(19) United States
(12) Patent Application Publication
(10) Pub. No.: US 2008/0100198 A1
(43) Pub. Date: May 1, 2008

(54) LIGHT EMISSION DEVICE AND DISPLAY DEVICE

(76) Inventor: Su-Joung Kang, Yongin-si (KR)

Correspondence Address: CHRISTIE, PARKER & HALE, LLP, PO BOX 7068, PASADENA, CA, 91109-7068, US

(21) Appl. No.: 11/843,368

(22) Filed: Aug. 22, 2007

(30) Foreign Application Priority Data
Oct. 31, 2006 (KR) 10-2006-0106697

(51) Int. Cl. H01J 1/62

(52) U.S. Cl. 313/497

(57) ABSTRACT

A light emission device and a display device using the light emission device as a light source are provided. The light emission device includes a vacuum vessel having first and second substrates and a sealing member, an electron emission unit provided on an inner surface of the first substrate and having driving electrodes and electron emission regions, a light emission unit provided on an inner surface of the second substrate, a plurality of spacers located between the first and second substrates, and a resistive layer formed on the first substrate and coupled to at least one of the driving electrodes. The resistive layer surrounds a circumference of the spacer.

### CROSS-REFERENCE TO RELATED APPLICATION

This application claims priority to and the benefit of Korean Patent Application No. 10-2006-0106697 filed in the Korean Intellectual Property Office on Oct. 31, 2006, the entire content of which is incorporated herein by reference.

### BACKGROUND OF THE INVENTION

1. Field of the Invention

The present invention relates to a light emission device and a display device, and more particularly, to a light emission device that can enhance luminance and a display device using the light emission device as a light source.

2. Description of the Related Art

A conventional light emission device includes a rear substrate provided with electron emission regions and a front substrate provided with a phosphor layer and an anode electrode. Electrons emitted from the electron emission regions excite the phosphor layer to emit visible light from the phosphor layer.

A sealing member is provided at edges of the front and rear substrates to seal them together and thus form a vacuum vessel whose inner space is exhausted. Spacers are located between the front and rear substrates to endure a compression force applied to the vacuum vessel.

When the light emission device is used as a light source of a display device, it is desirable to realize a high luminance with relatively low power consumption. However, in the conventional light emission devices, as a high voltage is applied to the anode electrode, arcing may occur in a vacuum vessel.

The arcing is generally caused by gas impurities contained in the vacuum vessel and electric charges on non-conductor surfaces (e.g., electric charges on the spacers). The arcing causes damage to the internal structure of the device and results in a defective device.

Therefore, a drawback of the conventional light emission device is that, because of the arcing, the voltage applied to the anode electrode cannot be sufficiently increased to realize a high luminance.

### SUMMARY OF THE INVENTION

Exemplary embodiments of the present invention provide a light emission device that can enhance luminance by suppressing the electric charging of spacers and the occurrence of arcing and a display device using the light emission device as a light source.

An exemplary embodiment of the present invention provides a light emission device including: a vacuum vessel having first and second substrates and a sealing member, an electron emission unit provided on an inner surface of the first substrate and having driving electrodes and electron emission regions, a light emission unit provided on an inner surface of the second substrate, a plurality of spacers located between the first and second substrates, and a resistive layer formed on the first substrate and coupled to at least one of the driving electrodes. The resistive layer surrounds a circumference of the spacer.

The driving electrodes may include first electrodes and second electrodes crossing the first electrodes with an insulating layer interposed between the first and second electrodes, and the electron emission regions are electrically coupled to the first electrodes or the second electrodes.

The spacers may be located on the insulating layer between the second electrodes. The resistive layer may be formed on the insulating layer while surrounding the circumference of the spacer and contacting the second electrodes.

The resistive layer may have an extending portion located between the second electrodes, and in parallel with the second electrodes, or may be formed on an entire portion between at least a pair of the second electrodes except for a portion where the spacer is formed.

A width of the spacer in a width direction of the second electrode may be greater than a distance between two adjacent second electrodes, and a recess portion may be formed in the adjacent second electrodes such that the second electrodes receive the spacer and the resistive layer corresponding to a portion where the spacer is mounted. The resistive layer may have a resistivity or specific resistance ranging from 10⁶ to 10¹² Ωcm.

Another exemplary embodiment of the present invention provides a display device including: a display panel for displaying an image, and a light emission device emitting light toward the display panel, wherein the light emission device includes a vacuum vessel having first and second substrates and a sealing member, an electron emission unit provided on an inner surface of the first substrate and having driving electrodes and electron emission regions, a light emission unit provided on an inner surface of the second substrate, a plurality of spacers located between the first and second substrates, and a resistive layer formed on the first substrate and coupled to at least one of the driving electrodes, the resistive layer surrounding a circumference of each spacer.

The display panel may include first pixels, and the light emission device may include second pixels. The second pixels may be fewer than the first pixels. A light emission intensity of each of the second pixels may be independently controlled. The display panel may be a liquid crystal display panel.

### BRIEF DESCRIPTION OF THE DRAWINGS

FIG. 1 is a cross-sectional view of a light emission device according to a first exemplary embodiment of the present invention.

FIG. 2 is a partially cut-away perspective view of an active region of the light emission device of FIG. 1.

FIG. 3A is a partial cross-sectional view of an electron emission unit of the light emission device of FIG. 1, before a spacer is mounted.

FIG. 3B is a partial cross-sectional view of an electron emission unit of the light emission device of FIG. 1, after a spacer is mounted.

FIG. 4 is a partial plan view of an electron emission unit and a spacer of a light emission device according to a second exemplary embodiment of the present invention.

FIG. 5 is a partial plan view of an electron emission unit and a spacer of a light emission device according to a third exemplary embodiment of the present invention.

FIG. 6 is an exploded perspective view of a display device according to an exemplary embodiment of the present invention.

### DETAILED DESCRIPTION

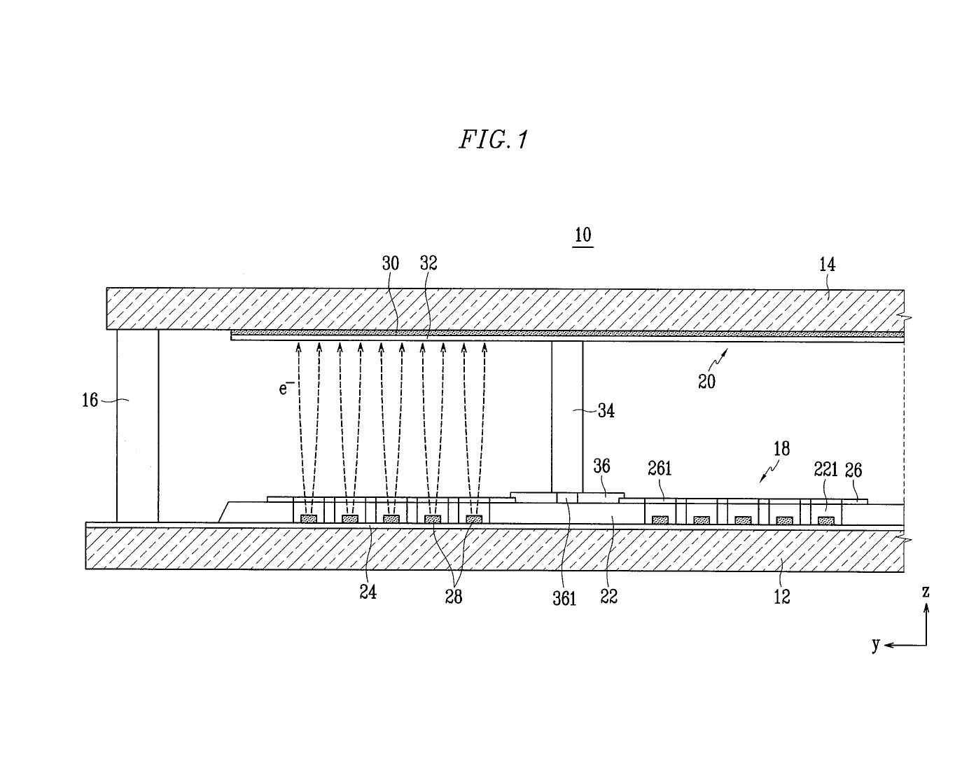

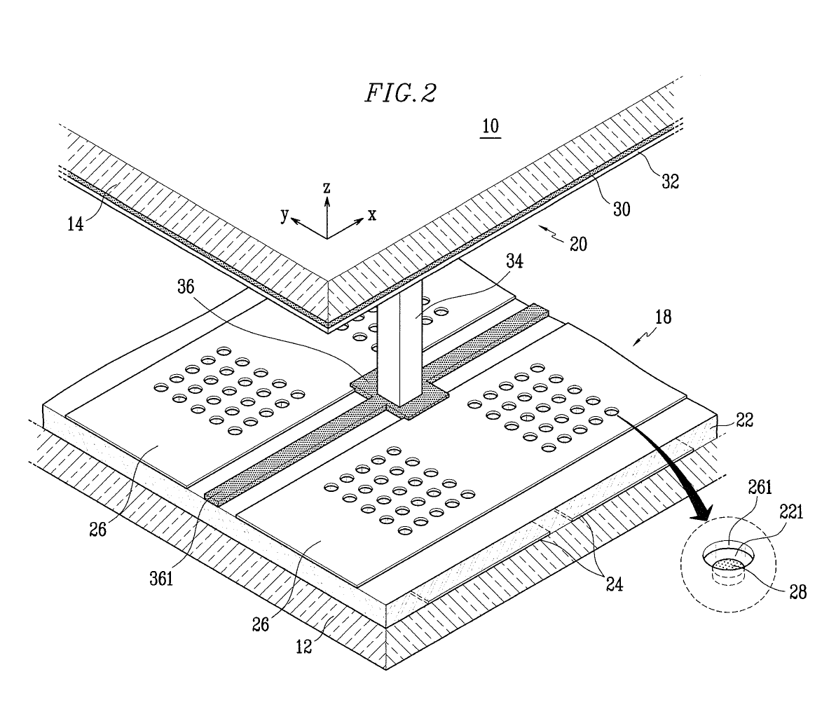

Referring to FIGS. 1 and 2, a light emission device 10 of the present embodiment includes first and second substrates 12 and 14 facing each other in parallel and being set apart at a distance or a gap from each other. The gap between the two substrates may be predetermined. A sealing member 16 is provided at edges of the first and second substrates 12 and 14 to seal them together and thus form a vacuum vessel. The interior of the vacuum vessel is exhausted to and kept at a vacuum of about 10⁻⁶ Torr of pressure.

Inside the vacuum vessel, formed by sealing member 16, each of the first and second substrates 12 and 14 is divided into an active region for emitting visible light and an inactive region surrounding the active region. An electron emission unit 18 for emitting electrons is provided on the active region of an inner surface of the first substrate 12 and a light emission unit 20 for emitting visible light is provided on the active region of an inner surface of the second substrate 14.

The electron emission unit 18 includes first electrodes 24 arranged in a stripe pattern, second electrodes 26 arranged in a stripe pattern crossing the first electrodes 24, and electron emission regions 28 electrically coupled to the first electrodes 24 or the second electrodes 26. An insulating layer 22 is interposed between the first and second electrodes 24 and 26.

When the electron emission regions 28 are formed on the first electrodes 24, the first electrodes 24 function as cathode electrodes applying a current to the electron emission regions 28 and the second electrodes 26 function as gate electrodes for inducing electron emission by forming an electric field corresponding to a voltage difference between the gate and cathode electrodes. On the contrary, when the electron emission regions 28 are formed on the second electrodes 26, the second electrodes 26 function as the cathode electrodes and the first electrodes 24 function as the gate electrodes.

One of the first and second electrodes 24 and 26 (e.g., the second electrode 26), which is parallel with the row direction of the light emission device 10, may function as a scan electrode and may receive a scan driving voltage. The other electrode (e.g., the first electrode 24), that is parallel with a column direction of the light emission device 10, may function as a data electrode and receive a data driving voltage.

In FIGS. 1 and 2, an embodiment where the electron emission regions 28 are formed on the first electrode 24 is illustrated as an example. In this embodiment, openings 261 and openings 221 are respectively formed through the second electrodes 26 and the insulating layer 22 at each crossing region of the first and second electrodes 24 and 26 to partly expose the surface of the first electrodes 24. The electron emission regions 28 are formed on the first electrodes 24 in the openings 221 of the insulating layer 22.

The electron emission regions 28 may be formed of a material emitting electrons when an electric filed is applied to the material, such as a carbon-based material or a nanometer-size material. For example, the electron emission regions 28 can be formed of carbon nanotubes, graphite, graphite nanofibers, diamonds, diamond-like carbon, fullerene C₆₀, silicon nanowires or a combination thereof.

Alternatively, the electron emission regions may be formed in a tip structure formed of a Mo-based or Si-based material.

With the above-described structure, one crossing region of the first and second electrodes 24 and 26 may correspond to one pixel region. Alternatively, two or more crossing regions of the first and second electrodes 24 and 26 may correspond to one pixel region. In the latter case, the two or more first electrodes 24 and/or the two or more second electrodes 26 that are placed at the same pixel region are electrically coupled to one another to receive a common voltage.

The light emitting unit 20 includes a phosphor layer 30 and an anode electrode 32 located on a surface of the phosphor layer 30. The phosphor layer 30 may be formed with red, green, and blue phosphors, a combination of which emits white light. The phosphor layer 30 may be formed on an entire surface of the second substrate 14 at the active region or formed in a predetermined pattern corresponding to the pixel regions.

The anode electrode 32 may be a metal layer such as an aluminum layer covering a surface of the phosphor layer 30. The anode electrode 32 is an acceleration electrode that receives a high voltage to maintain the phosphor layer 30 at a high electric potential state. The anode electrode 32 may function to enhance the luminance by reflecting the visible light, which is emitted from the phosphor layer 30 toward the first substrate 12, back toward the second substrate 14.

Spacers 34 are located between the first and second substrates 12 and 14 for enduring the compression force applied to the vacuum vessel and for uniformly maintaining the gap between the first and second substrates 12 and 14. The spacers 34 are located outside the crossing regions of the first and second electrodes 24 and 26. For example, the spacers 34 may be located corresponding to portions defined between the second electrodes 26 at portions defined between the first electrodes 24.

The spacers 34 may be formed in a pillar shape having a rectangular or circular cross-section or in a bar shape. A pillar being substantially vertical to the substrates and a bar being substantially horizontal with the substrates. The spacers 34 may be formed of glass, ceramic, tempered glass, or glass-ceramic mixture. For convenience, only one rectangular pillar type spacer 34 is illustrated in FIGS. 1 and 2.

In the present exemplary embodiment, a resistive layer 36 is formed on the portion defined between the second electrodes 26 while surrounding a circumference of the spacer 34. The resistive layer 36 contacts the second electrodes 26. The resistive layer 36 may have a predetermined width.

The resistive layer 36 has a specific resistance ranging from about 10⁶ to about 10¹² Ωcm. The resistive layer 36 allows electric charges collected on a surface of the spacer 34 to flow to the second electrode 26. Since the resistive layer 36 is formed from a high resistance material, no short circuit will occur between the adjacent second electrodes 26 through the resistive layer 36.

The resistive layer 36 is formed around the circumference of the spacer 34 on a surface of the insulating layer 22. The resistive layer 36 may be formed with a predetermined width around the circumference of the spacer 34. The resistive layer 36 includes an extending portion 361 that is arranged between the second electrodes 26 and in parallel with the second electrodes 26.

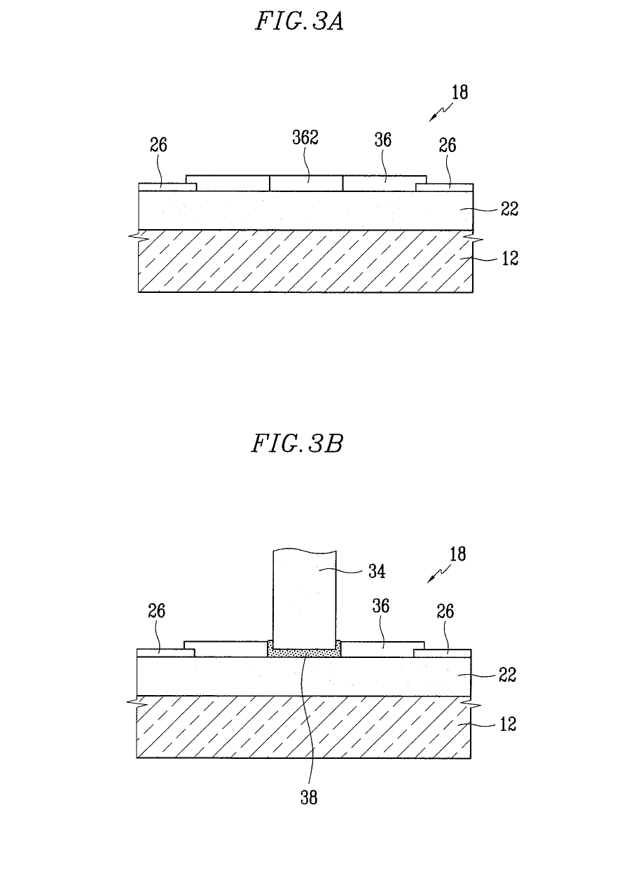

FIGS. 3A and 3B are partial cross-sectional views of the electron emission unit 18 of the light emission device of FIG. 1, before and after the spacer 34 is mounted, respectively.

Referring to FIG. 3A, after the second electrodes 26 are formed on the insulating layer 22, the resistive layer 36 is formed using a material having the above-described specific resistance. The resistive layer 36 may be formed from amorphous silicon doped with p-type or n-type impurities or a mixture of a conductive material and an insulation material. An opening 362 where the spacer 34 will be positioned may be formed in the resistive layer 36 through a photolithography process.

Referring to FIG. 3B, the spacer 34 is fixed in the opening 362 of the resistive layer 36 using an adhesive material such as glass frit. An adhesive layer 38 for fixing the spacer 34 may contain a conductive material. In this case, electric charges collected on the surface of the spacer 34 can be more effectively transferred to the resistive layer 36. The resistive layer 36 prevents the adhesive material from overflowing when the spacer 34 is being mounted.

The above-described light emission device 10 is driven by applying driving voltages to the first electrodes 24 and the second electrodes 26, and applying several thousands of volts of a positive direct current (DC) voltage (anode voltage) to the anode electrode 32. The driving voltages may be predetermined.

As a result of the application of the driving voltages, electric fields are formed around the electron emission regions 28 at the pixels where the voltage difference between the first and second electrodes 24 and 26 is equal to or great than a threshold value, and thus electrons are emitted from the electron emission regions 28. The emitted electrons are attracted by the anode voltage to collide with a corresponding portion of the phosphor layer 30. Consequently, the phosphor layer 30 emits visible light. Light emission intensity of the phosphor layer 30 of each pixel corresponds to intensity of emitted electron beams at the pixel.

In the above-described driving process, some of the electrons collide with a surface of the spacer 34 due to the diffusion of the electron beams. As a result, the surface of the spacer 34 is positively or negatively charged according to its material properties (e.g., dielectric constant, secondary electron emission coefficient, and the like).

Because the resistive layer 36 functions to allow the electric charges collecting on the surface of the spacer 34 to flow to the second electrode 26, the electric charging of the surface of the spacer 34 can be minimized.

Accordingly, the light emission device 10 of the present exemplary embodiment can suppress arcing in the vacuum vessel. Therefore, a higher voltage can be applied to the anode electrode 32, thereby enhancing the luminance of the light emission surface.

In addition, in the present exemplary embodiment, the gap between the first and second substrates 12 and 14 may range from 5 to 20 mm and a high voltage of above 10 kV, for example, about 10-15 kV, can be applied to the anode electrode 32 through an anode voltage applying portion (not shown). Accordingly, the light emission device 10 realizes a peak luminance about 10,000 cd/m² at a central portion of the active region.

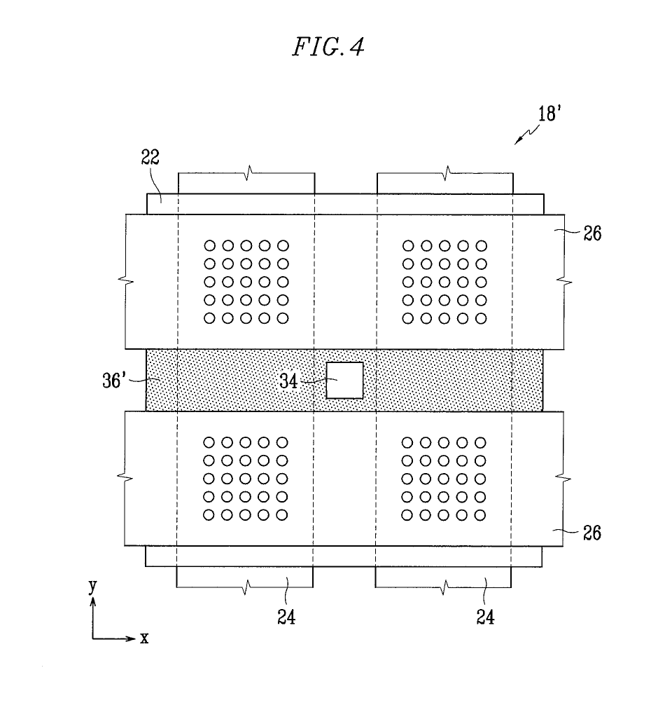

FIG. 4 is a partial plan view of an electron emission unit 18′ and a spacer of a light emission device according to a second exemplary embodiment of the present invention.

Referring to FIG. 4, a light emission device of the second exemplary embodiment has a basic structure similar to that of the first exemplary embodiment. However, in the second exemplary embodiment, a resistive layer 36′ is formed on an entire portion defined between the second electrodes 26.

The resistive layer 36′ is formed on an entire surface of the insulating layer 22 while not covering the second electrodes 26 to effectively suppress the electric charging of the surface of the insulating layer 22 as well as the surface of the spacer 34.

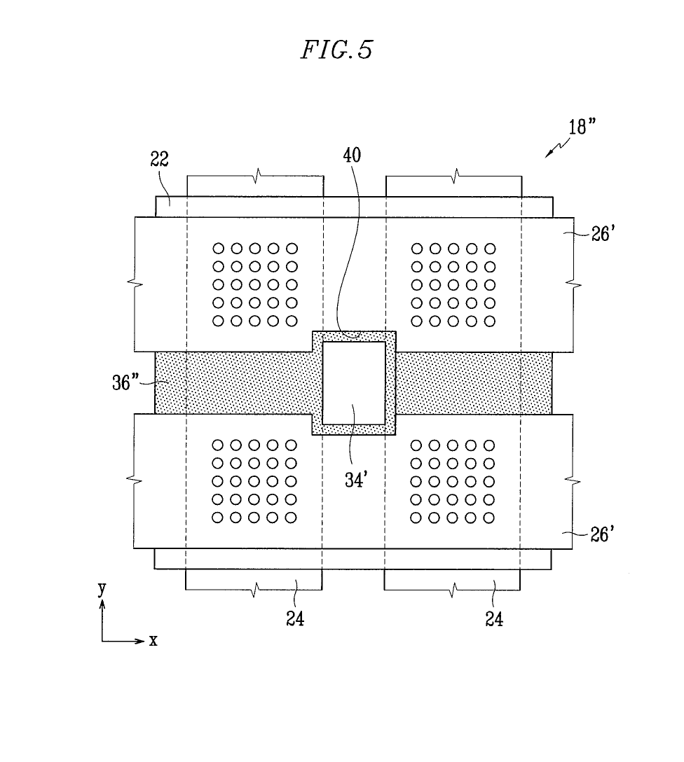

FIG. 5 is a partial plan view of an electron emission unit 18″ and a spacer of a light emission device according to a third exemplary embodiment of the present invention.

Referring to FIG. 5, in the third exemplary embodiment, a width of a spacer 34′, measured across the width direction of a second electrode 26′, is greater than a distance between the second electrodes 26′. A recess portion 40 is formed in a mounting region of the spacer 34′ in the second electrodes 26′ such that the second electrodes 26′ can receive the spacer 34′ and a resistive layer 36″.

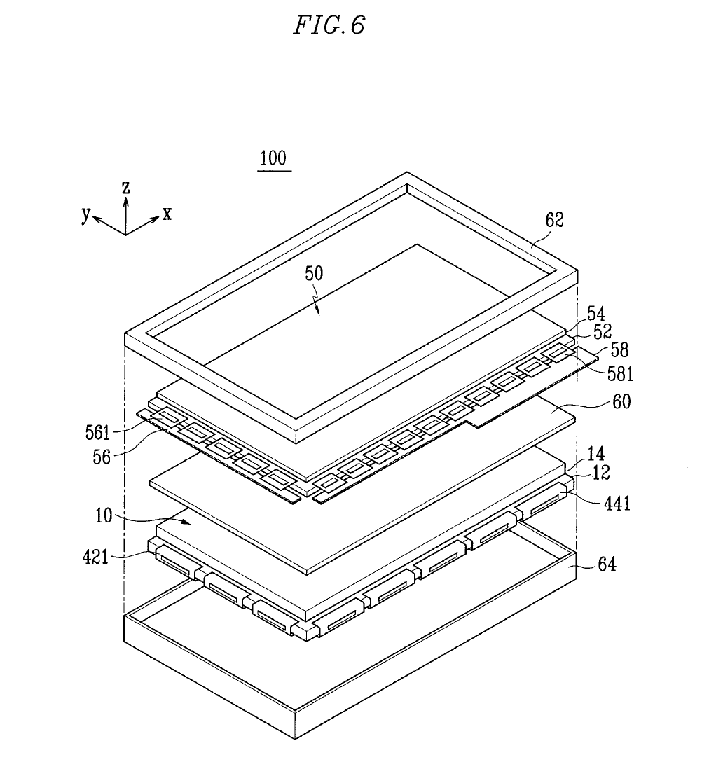

FIG. 6 is an exploded perspective view of a display device, according to an exemplary embodiment of the present invention, which may use the above-described light emission devices as a light source. The display device illustrated in FIG. 6 is exemplary only, not limiting the present invention.

Referring to FIG. 6, a display device 100 of the present exemplary embodiment includes a light emission device 10 and a display panel 50 located in front, i.e. the side of the second substrate 14, of the light emission device 10. A diffuser 60 may be located between the light emission device 10 and the display panel 50 to uniformly diffuse light emitted from the light emission device 10 toward the display panel 50. The diffuser 60 may be spaced apart from the light emission device 10 by a predetermined distance. Top and bottom chassis 62 and 64 are respectively installed in front of the display panel 50 and in rear of the light emission device 10. Front in FIG. 6 refers to the positive direction of the z-axis shown in the drawing which corresponds to a side of the display device where the image is displayed. Conversely, the back direction in FIG. 6 corresponds to the negative direction of the z-axis.

The display panel 50 may be a liquid crystal display panel or another type of light receiving display panel. A liquid crystal display panel being used as the display panel 50 is described below.

The display panel 50 includes a thin film transistor (TFT) substrate 52 on which a plurality of TFTs are arranged in an array and a color filter substrate 54 located above the TFT substrate 52, and a liquid crystal layer (not shown) located between the TFT substrate 52 and the color filter substrate 54. Polarizing plates (not shown) are attached on a front surface of the color filter substrate 54 and a back surface of the TFT substrate 52 to polarize light passing through the display panel 50.

Data lines are coupled to corresponding source terminals of the TFTs and gate lines are coupled to corresponding gate terminals of the TFTs. Pixel electrodes formed of a transparent conductive layer are coupled to corresponding drain terminals of the TFTs.

Electrical signals are input from a gate circuit board assembly 56 and a data circuit board assembly 58 to the gate and data lines, respectively, and from the gate and data lines to the gate and source terminals of the TFTs, respectively. The TFTs are turned on or off according to the input signals so that electrical signals required for driving the pixel electrodes are provided to the drain terminals.

The color filter substrate 54 may have red, green and blue color filters that can emit colored light as the light passes through the color filter substrate 54. A common electrode (not shown) is formed from a transparent conductive layer on an entire surface of the color filter substrate 54. When the TFT is turned on by applying electrical power to the gate and source terminals, an electric field is formed between the pixel electrode and the common electrode. Due to the electric field, the twisting angle of the liquid crystal molecules of the liquid crystal layer varies to control an amount of light transmitted through each pixel.

The gate and data circuit board assemblies 56 and 58 of the display panel 50 are coupled to respective driving IC packages 561 and 581. In order to drive the display panel 50, the gate circuit board assembly 56 transmits a gate driving signal while the data circuit board assembly 58 transmits a data driving signal.

The number of pixels of the light emission device 10 is less than the number of pixels of the display panel 50 so that each pixel of the light emission device 10 corresponds to two or more pixels of the display panel 50. Each pixel of the light emission device 10 emits light in response to a highest gray level among the gray levels of the corresponding pixels of the display panel 50. In one exemplary embodiment, the light emission device can represent 2-bit to 8-bit gray levels for each of the pixels representing 4 to 256 shades of gray.

For convenience, the pixels of the display panel 50 will be referred to as first pixels and the pixels of the light emission device 10 will be referred to as second pixels. The first pixels corresponding to one of the second pixels will be referred to as a first pixel group.

In order to drive the light emission device 10, a signal controller (not shown) controlling the display panel 50 detects a highest gray level among gray levels of the first pixels of the first pixel group, calculates a gray level required for emitting light from the corresponding second pixel in accordance with the detected highest gray level, converts the calculated gray level into digital data, and generates a driving signal for the light emission device 10 using the digital data. The driving signal of the light emission device 10 includes a scan driving signal and a data driving signal.

Scan and data circuit board assemblies (not shown) of the light emission device 10 are respectively coupled to driving IC packages 421 and 441. In order to drive the light emission device 10, the scan circuit board assembly transmits the scan driving signal while the data circuit board assembly transmits a data driving signal. One of first and second electrodes 24 and 26 receives the scan driving signal and the other receives the data driving signal.

When the image is displayed by the first pixel group, corresponding to one second pixel of the light emission device 10, the second pixel emits light with a predetermined gray level by synchronizing with the first pixel group. As described above, the light emission device 10 independently controls the intensity of the light emission of each of the second pixels included on the light emission device 10. The display device 100 of the present exemplary embodiment can enhance the dynamic contrast of the screen and improve the image quality.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A light emission device comprising:
a vacuum vessel having a first substrate and a second substrate and a sealing member;
an electron emission unit provided on an inner surface of the first substrate and having driving electrodes and electron emission regions;
a light emission unit provided on an inner surface of the second substrate;
a plurality of spacers located between the first substrate and the second substrate; and
a resistive layer formed on the first substrate and coupled to at least one of the driving electrodes, the resistive layer surrounding a circumference of one or more of the plurality of spacers.

2. The light emission device of claim 1,
wherein the driving electrodes include first electrodes and second electrodes crossing the first electrodes with an insulating layer interposed between the first electrodes and the second electrodes; and
wherein the electron emission regions are electrically coupled to the first electrodes or the second electrodes.

3. The light emission device of claim 2, wherein the plurality of spacers are located on the insulating layer between the second electrodes.

4. The light emission device of claim 3, wherein the resistive layer is formed on the insulating layer and contacts at least one of the second electrodes.

5. The light emission device of claim 4, wherein the resistive layer includes an extending portion located between a pair of the second electrodes and parallel to the pair of the second electrodes, members of the pair of the second electrodes being adjacent each other.

6. The light emission device of claim 4, wherein the resistive layer covers all of an area between a pair of the second electrodes except a portion of the area between the pair of the second electrodes corresponding to spacers located between the pair of the second electrodes, members of the pair of the second electrodes being adjacent each other, the spacers being from among the plurality of spacers.

7. The light emission device of claim 4,
wherein a width of spacers in a width direction of the second electrodes is greater than a distance between members of a pair of the second electrodes, the spacers being from among the plurality of spacers and being located between the members of the pair of the second electrodes, the members of the pair of the second electrodes being adjacent each other, and
wherein a recess portion is formed in each member of the pair of the second electrodes to receive each of the spacers and the resistive layer.

8. The light emission device of claim 1, wherein the resistive layer has a specific resistance ranging substantially from 10⁶ to 10¹² Ωcm.

9. A display device comprising:
a display panel for displaying an image; and
a light emission device emitting light toward the display panel,
wherein the light emission device comprises a vacuum vessel having a first substrate and a second substrate and a sealing member, an electron emission unit provided on an inner surface of the first substrate and having driving electrodes and electron emission regions, a light emission unit provided on an inner surface of the second substrate, a spacer located between the first substrate and the second substrate, and a resistive layer formed on the first substrate and coupled to at least one of the driving electrodes, the resistive layer surrounding a circumference of the spacer.

10. The display device of claim 9,
wherein the driving electrodes include first electrodes and second electrodes crossing the first electrodes with an insulating layer interposed between the first electrodes and the second electrodes, and
wherein the electron emission regions are electrically coupled to the first electrodes or the second electrodes.

11. The display device of claim 10,
wherein the spacer is located on the insulating layer between the second electrodes, and
wherein the resistive layer is formed on the insulating layer and contacts the second electrodes.

12. The display device of claim 11, wherein the resistive layer has an extending portion located between the second electrodes and parallel to the second electrodes.

13. The display device of claim 11, wherein the resistive layer covers all of an area between the pair of the second electrodes except a portion of the area between the pair of the second electrodes corresponding to the spacer.

14. The display device of claim 11,
wherein a width of the spacer in a width direction of the second electrodes is greater than a distance between two adjacent ones of the second electrodes, and
wherein a recess portion is formed in the second electrodes to receive the spacer and the resistive layer.

15. The display device of claim 9,
wherein the display panel includes first pixels, and
wherein the light emission device includes second pixels, the second pixels being fewer than the first pixels, a light emission intensity of each of the second pixels being independently controlled.

16. The display device of claim 9, wherein the display panel is a liquid crystal display panel.

17. A light emission device comprising:
a vacuum vessel having a first substrate and a second substrate and a sealing member, the first substrate being located opposite from the second substrate and being separated from the second substrate by the sealing member;
an electron emission unit provided on an inner surface of the first substrate and having driving electrodes and electron emission regions, the driving electrodes including first electrodes and second electrodes crossing over the first electrodes;
a light emission unit provided on an inner surface of the second substrate;
a plurality of spacers located between the first substrate and the second substrate; and
a resistive layer formed on the first substrate and coupled to one or more of the driving electrodes, the resistive layer surrounding a circumference of each spacer from among the plurality of spacers,
wherein the resistive layer is adapted to dissipate charges collected on the plurality of spacers through the driving electrodes,
wherein the resistive layer has a specific resistance substantially higher than a specific resistance of the driving electrodes.

18. The light emission device of claim 17, further comprising:
an insulating layer interposed between the first electrodes and the second electrodes,
wherein the electron emission regions are electrically coupled to the first electrodes or to the second electrodes.

19. The light emission device of claim 17, wherein the plurality of spacers are located on the insulating layer and in between the second electrodes.

20. The light emission device of claim 17, wherein the resistive layer is formed on the insulating layer and contacts a pair of the second electrodes, the pair of the second electrodes being adjacent to each other and being adjacent to spacers located between members of the pair of the second electrodes, the spacers being from among the plurality of spacers.
